(19) United States
(12) Patent Application Publication
(10) Pub. No.: US 2025/0313232 A1
(43) Pub. Date: Oct. 9, 2025

(54) LOCALIZATION OF A GROUND VEHICLE USING DATA LAYERS

(71) Applicant: AUTOBRAINS TECHNOLOGIES LTD, Tel Aviv-Yafo (IL)

(72) Inventors: Igal RAICHELGAUZ, Tel Aviv (IL); Adam HAREL, Tel Aviv (IL); Maya RAPAPORT, Tel Aviv-Yafo (IL); Max MONASTIRSKY, Tel Aviv-Yafo (IL); Alon ESHEL, Tel-Aviv-Yafo (IL)

(73) Assignee: AUTOBRAINS TECHNOLOGIES LTD, Tel Aviv-Yafo (IL)

(21) Appl. No.: 19/201,960

(22) Filed: May 8, 2025

Related U.S. Application Data
(63) Continuation-in-part of application No. 18/739,321, filed on Jun. 11, 2024.
(63) Continuation-in-part of application No. 18/527,701, filed on Dec. 4, 2023.

(51) Int. Cl. B60W 60/00; G06V 20/10; G06V 20/17; G06V 20/56

(52) U.S. Cl. CPC B60W 60/001; G06V 20/17; G06V 20/182; G06V 20/588; B60W 2420/403; B60W 2552/53

(57) ABSTRACT

A method that includes obtaining, by a processor associated with the vehicle, a cross-view based localization of the vehicle that is determined by using air based data in accordance with environmental information sensed by a sensor of the vehicle at the region of the vehicle. Then, obtaining, by accessing a database that is populated to contain a data layer, data layer information regarding locations of a given road setting within the region of the vehicle; obtaining, in real time, ground detection output that is being generated for the given road setting by a perception unit of the vehicle; and providing real-time fine-tuned localization of the vehicle, by continuous alignment of the ground detection output in accordance with the data layer information, for the given road setting.

### CROSS REFERENCE

This application is a continuation in part of U.S. patent application Ser. No. 18/739,321 filing date Jun. 11, 2024 which is incorporated herein by reference.

This application is a continuation in part of U.S. patent application Ser. No. 18/527,701 filing date Dec. 4, 2023 which is incorporated herein by reference.

### BACKGROUND

Vehicle environment information is critical for systems relating to the autonomous driving of ground autonomous vehicles (AVs). Such vehicle environment information may include, for example, the location of the ground vehicle, which is used for planning a next driving operation of the ground vehicle, for navigating the ground vehicle, for determining applicable driving laws, and the like.

The location of the ground vehicle should be accurate, should be updated frequently, should be easily accessible by an AV system of the ground vehicle, and should be highly secure.

Current localization solutions rely on maps produced, for example, by ground image capture, and city/street planning information. These maps may be constantly updated based on inputs provided by multiple ground vehicles. These solutions require that the locations determined using the high-definition map be driven by many ground vehicles, and in some instances, only by the same type of ground vehicle. These solutions also depend on the existence of predetermined landmarks at the current location of the ground vehicle, and some locations may not be associated with these landmarks.

There is a growing need to provide an accurate and efficient method for locating the ground vehicle without having a predetermined high-definition map that includes landmarks identified from images sensed by other ground vehicles.

### SUMMARY

There is provided a method, a non-transitory computer readable medium and a system as illustrated in the specification.

### BRIEF DESCRIPTION OF THE DRAWINGS

The embodiments of the disclosure will be understood and appreciated more fully from the following detailed description, taken in conjunction with the drawings in which:

FIGS. 1A-1C are schematic diagrams of a system for determining a vehicle location and system components according to embodiments of the disclosure;

FIG. 2 illustrates a ground vehicle and a plurality of vehicle sensors present in the ground vehicle;

FIG. 3A illustrates an example of a vehicle;

FIG. 3B illustrates an example of a vehicle;

FIG. 3C illustrates an example of a vehicle;

FIG. 4A illustrates an example of a method;

FIG. 4B illustrates an example of content stored in one or more storage/memory

units for use in implementing the method of FIG. 4A;

FIG. 5A illustrates an example of a method; and

FIG. 5B illustrates an example of a method; and

FIG. 5C illustrates an example of a method.

### DETAILED DESCRIPTION

According to an embodiment there is a growing need to improve the localization of a vehicle.

According to an embodiment there is provided a method for improved localization of a vehicle, the method that include using different types of information that may be used for localizing a vehicle—including localization information obtained using air based data and environmental information sensed by the data vehicle, and additional information from a database populated to include data layer information.

Using different types of information that differ from each other by the manner of acquisition and/or the updating parameter improves the accuracy of localization.

According to an embodiment, the road objects are road lanes or rather road lanes borders.

According to an embodiment, the method includes obtaining, by a processor associated with the vehicle, localization information regarding a location of the vehicle, wherein the localization information is obtained based on air based data within a region of the vehicle and on environmental information sensed by the vehicle. According to an embodiment, the localization information is based on a movement estimate of the vehicle and on probabilistic location information indicative of a location of the vehicle within the air based data. An example of the generating of the localization information is illustrated in U.S. patent application Ser. No. 18/527,701 filed on Dec. 4, 2023, which is incorporated herein by reference.

According to an embodiment, the method also includes obtaining, by the processor and by accessing a database populated to include data layer information, road object location information regarding locations of road objects within the region of the vehicle. According to an embodiment, examples of such database are illustrated in U.S. patent application Ser. No. 18/739,321 filed on Jun. 11, 2024, which is incorporated herein by reference. The data layer information may be associated with one or more layers that are selected out of multiple data layers, wherein each data layer is associated with a different type of object. According to an embodiment, the road object location information pertains to static road objects within the region of view of the vehicle—although it may also refer to dynamic road objects.

According to an embodiment, the method also includes applying the localization information and the road object location information in a real-time localization operation of the vehicle. According to an embodiment the real-time localization operation includes registering road objects, from the road object location information, and road objects, associated with the localization information, in a shared coordinate system.

According to an embodiment, the method also includes obtaining, in real time by the processor, ground perception data generated by a perception unit of the vehicle; and further applying the one or more vehicle location estimates in the real-time localization operation of the vehicle. According to an embodiment, the ground perception data includes road lanes data or data related to other road objects.

According to an embodiment, the method also includes registering road objects from the road object location information and road objects associated with the vehicle location estimates generated by the perception unit information in a shared coordinate system.

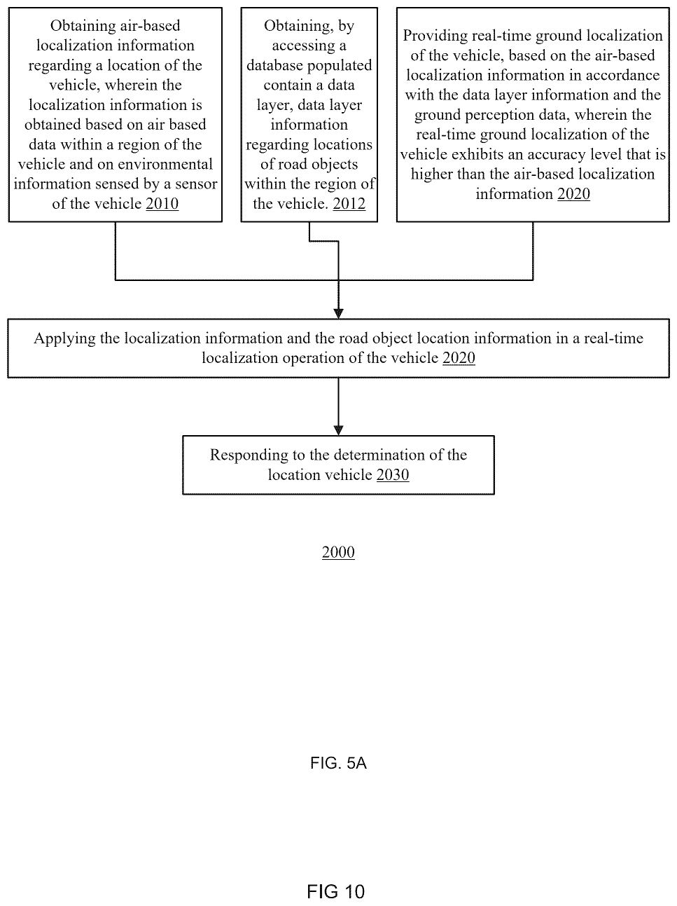

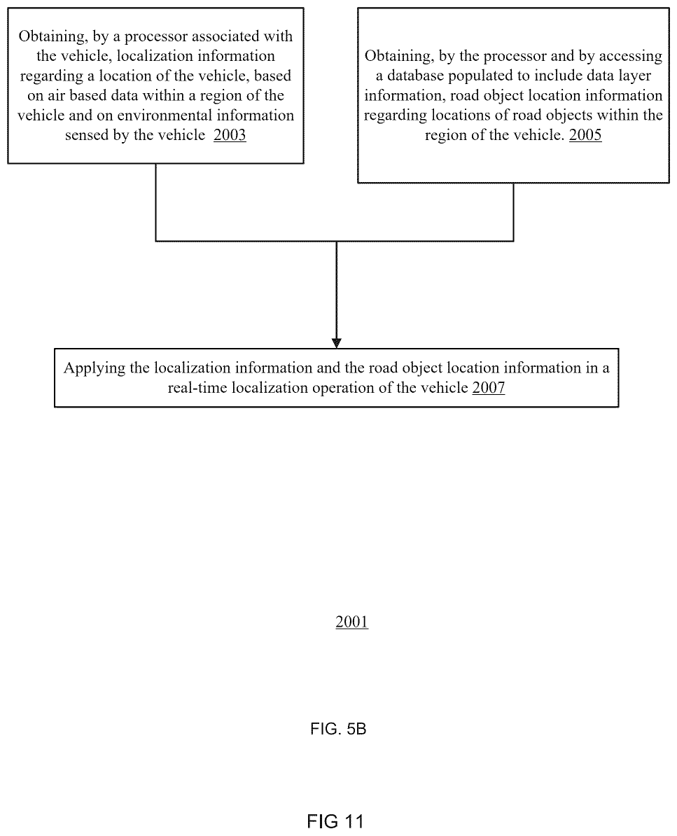

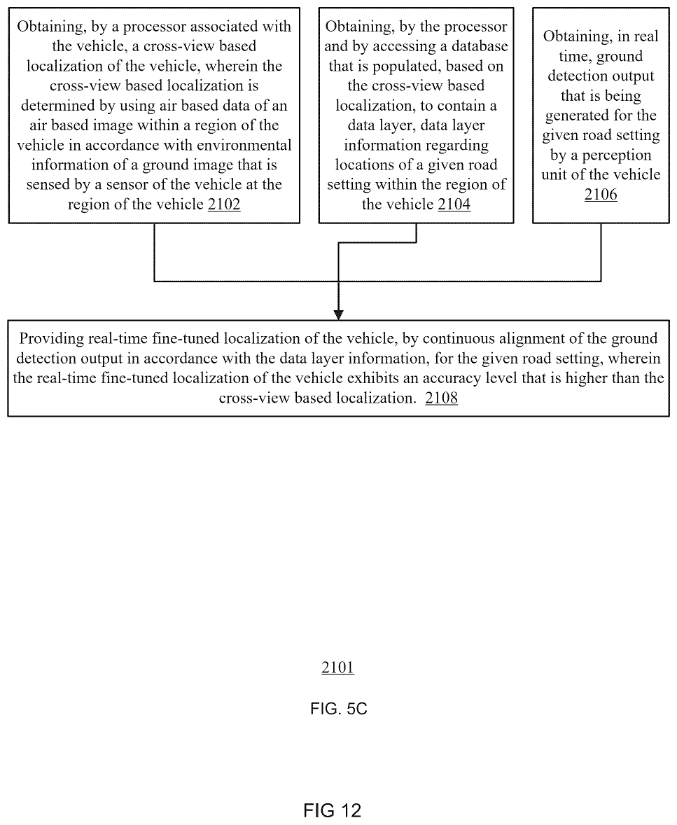

FIG. 5A illustrates an example of method 200 for improved localization of a vehicle.

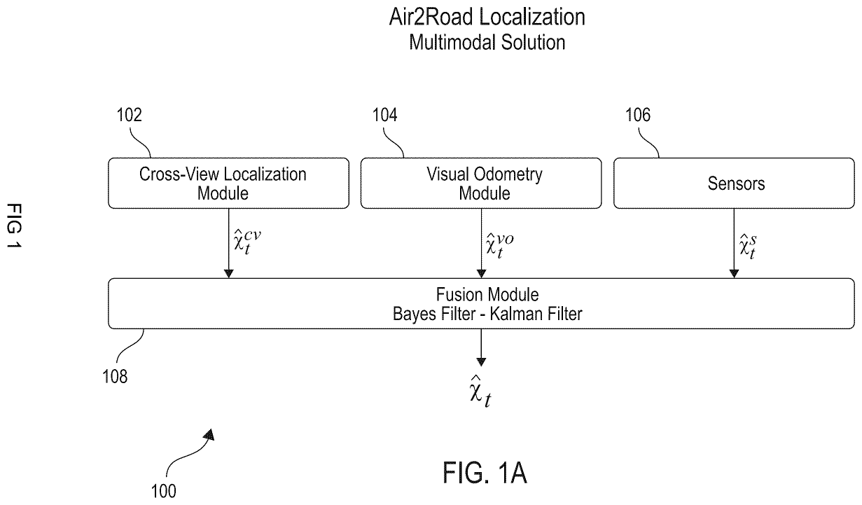

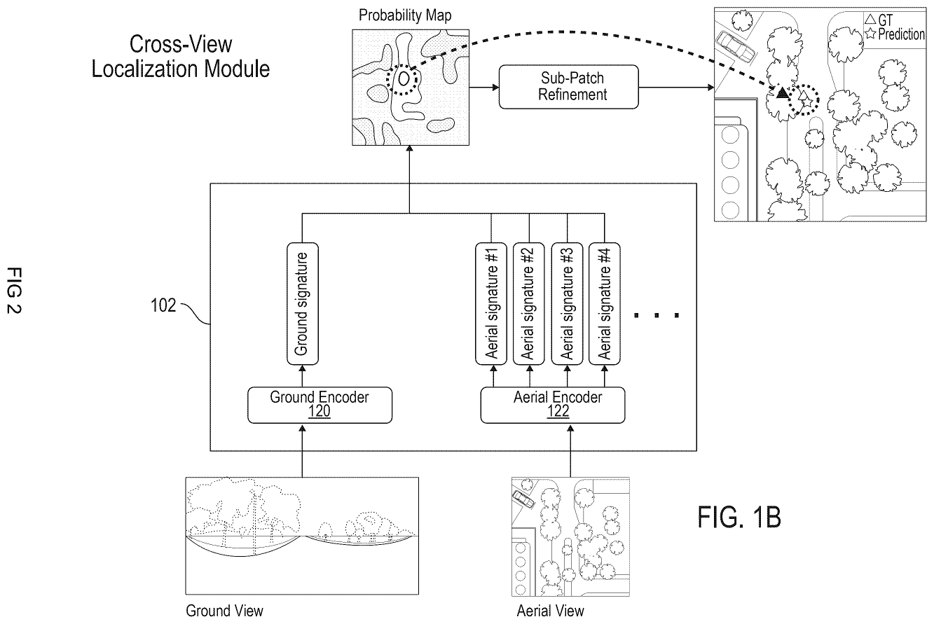

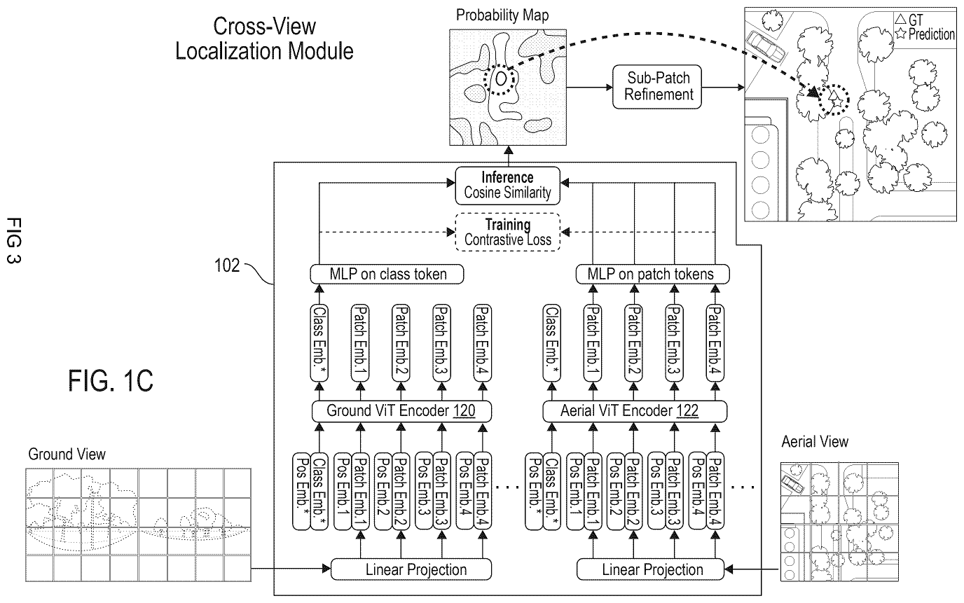

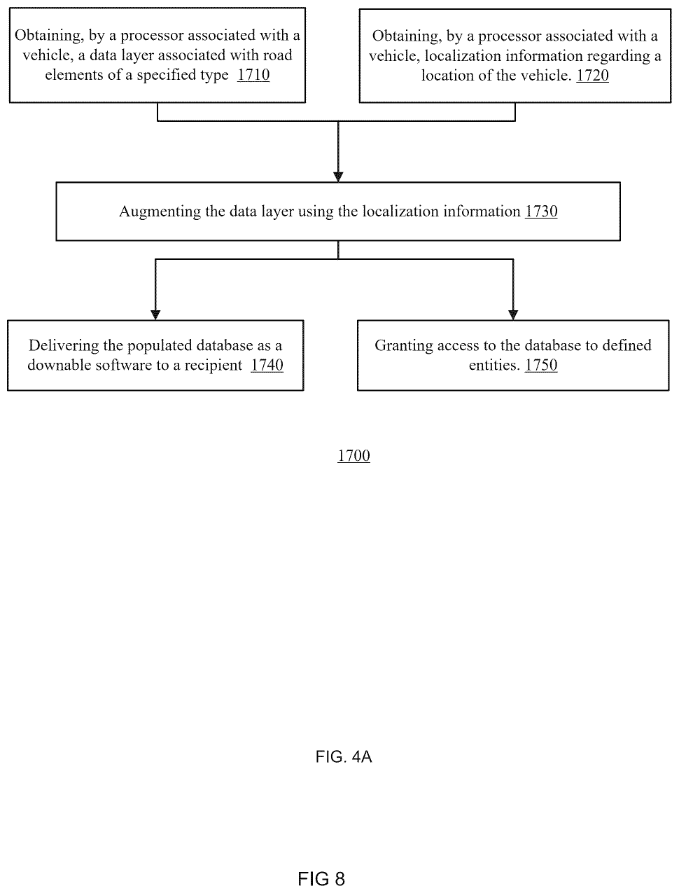

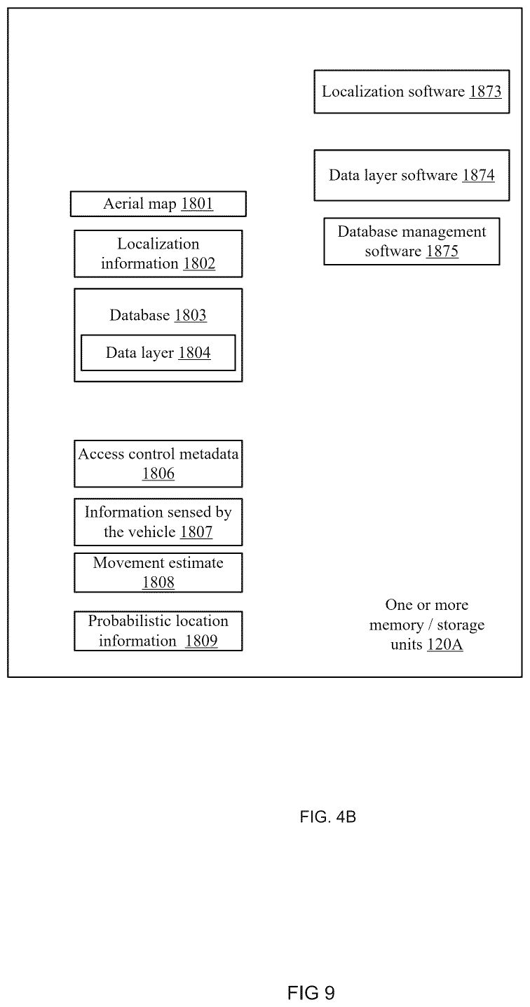

According to an embodiment, method 2000 includes step 2010 of obtaining, by a processor associated with the vehicle, localization information regarding a location of the vehicle, wherein the localization information is obtained based on air based data within a region of the vehicle and on environmental information sensed by the vehicle. According to an embodiment, the localization information is based on a movement estimate of the vehicle and on probabilistic location information indicative of a location of the vehicle within the air based data. As mentioned above, an example of the generating of the localization information is illustrated in U.S. patent application Ser. No. 18/527,701 filed on Dec. 4, 2023, which is incorporated herein by reference. According to an embodiment step 2010 is executed at least in part by a system such as system 100 of FIG. 1A-1C, the air based data is one or more aerial views, the environmental information sensed by the vehicle is one or more ground views, the probabilistic information is the probability information of FIG. 1C, and the localization information is or is generated by further processing the initial fusion results of FIG. 4.

According to an embodiment method 2000 also includes step 2012 of obtaining, by the processor and by accessing a database populated to include data layer information, road object location information regarding locations of road objects within the region of the vehicle. According to an embodiment examples of such database are illustrated in U.S. patent application Ser. No. 18/739,321 filing date Jun. 11, 2024 which is incorporated herein by reference.

According to an embodiment step 2010 is followed by step 2012 but steps 2010 and 2012 may be executed in parallel to each other. Step 2012 may be executed independently from step 2010 or may be dependent, at least in part, on one or more decisions and/or outputs of step 2010—for example estimates regarding the location of the vehicle. The estimate may be an initial estimate, an intermediate estimate or the outcome of step 2010. The location estimate may be provided from GPS or other resources outside the vehicle.

According to an embodiment, the data layer information may be associated with one or more layers that are selected out of multiple data layers, wherein each data layer is associated with a different type of object. According to an embodiment, the road object location information pertains to static road objects within the region of view of the vehicle-although it may also refer to dynamic road objects.

According to an embodiment steps 2010 and 2012 are followed by step 2020 of applying the localization information and the road object location information in a real-time localization operation of the vehicle. The outcome of step 2030 is a better determination of the location of the vehicle.

According to an embodiment step 2020 includes at least one of (a) assigning confidence levels to the localization made based on step 2010, (b) receiving confidence level estimates regarding the localization made based on step 2010, (c) assigning confidence levels to the localization based on step 2012, and/or (c) receiving confidence levels to the localization based on step 2012. The determining of the confidence levels may be based on ground truth data, on statistics regarding the accuracy of previous localization estimates, on an analysis of localization errors associated with the localization mechanisms, on the among of matching between the air based data and the environmental information sensed by the vehicle of step 2010, and the like.

According to an embodiment, step 2020 includes registering road objects, from the road object location information, and road objects, associated with the localization information, in a shared coordinate system.

According to an embodiment, method 2000 also includes step 2014 of obtaining, in real time by the processor, ground perception data generated by a perception unit of the vehicle; and further applying the one or more vehicle location estimates in the real-time localization operation of the vehicle. According to an embodiment, the ground perception data includes road lanes data or data related to other road objects. Step 2014 may be a part of step 2010.

According to an embodiment, step 2020 includes registering road objects from the road object location information and road objects associated with the vehicle location estimates generated by the perception unit information in a shared coordinate system.

According to an embodiment, step 2020 is followed by step 2030 of responding to the determination of the location vehicle. Step 2030 may include performing path planning based on the location of the vehicle, triggering or initiating or performing an training or an adaptation of any location related model or machine learning process based on the localization, associating a confidence level to any of the localization steps-the confidence level may represent a distance or a gap between the localization associated with the location related model or machine learning process and the outcome of step 2020, storing the localization information in a database and applying an access control policy to the location information, update and/or otherwise amend the content of the database. And the like.

FIG. 5B illustrates method 2001 for improving a localization of a vehicle.

According to an embodiment, method 2001 includes step 2003 of obtaining, by a processor associated with the vehicle, localization information regarding a location of the vehicle, based on air based data within a region of the vehicle and on environmental information sensed by the vehicle.

According to an embodiment, method 2001 includes step 2005 of obtaining, by the processor and by accessing a database populated to include data layer information, road object location information regarding locations of road objects within the region of the vehicle.

According to an embodiment, steps 2003 and 2005 are followed by step 2007 of applying the localization information and the road object location information in a real-time localization operation of the vehicle.

According to an embodiment the real-time localization process includes
Using the ground images and the air based image to get a base localization—for example using the method of illustrated in U.S. patent application Ser. No. 18/527,701 filed on Dec. 4, 2023, which is incorporated herein by reference.
Using ground level lane detections based on a knowledge of how the lanes look in this location.
Fine tuning the position of the vehicle position by moving/rotating/rolling the perspective, so the two outputs align-the detected lanes, and the known lanes data layer
Fine tuning the new position/perspective to provide a localization output that considers both the cross view localization (see FIGS. 1A-1C), and the ground level perception.

FIG. 5C illustrates an example of method 2101 that is computer implemented and is for improved localization of a ground vehicle.

According to an embodiment, method 2101 includes steps 2102, 2104 and 2016.

According to an embodiment, step 2102 includes obtaining, by a processor associated with the vehicle, a cross-view based localization of the vehicle, wherein the cross-view based localization is determined by using air based data of an air based image within a region of the vehicle in accordance with environmental information of a ground image that is sensed by a sensor of the vehicle at the region of the vehicle. As mentioned above, an example of the generating of the cross-view based localization is illustrated in U.S. patent application Ser. No. 18/527,701 filed on Dec. 4, 2023, which is incorporated herein by reference.

According to an embodiment, step 2104 includes obtaining, by the processor and by accessing a database that is populated, based on the cross-view based d localization, to contain a data layer, data layer information regarding locations of a given road setting within the region of the vehicle. According to an embodiment, examples of such database are illustrated in U.S. patent application Ser. No. 18/739,321 filed on Jun. 11, 2024, which is incorporated herein by reference.

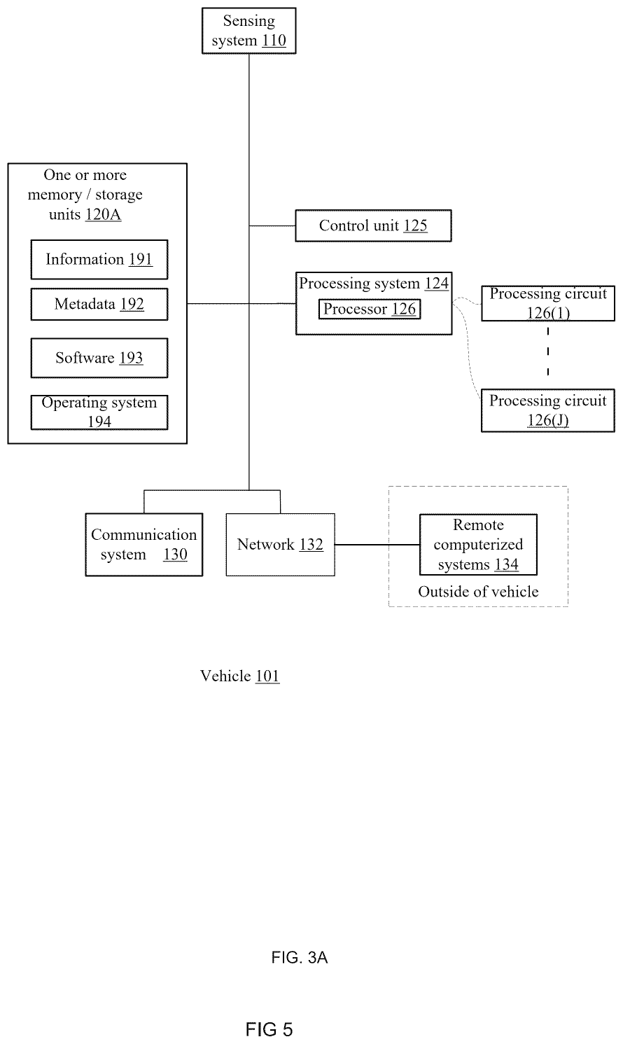

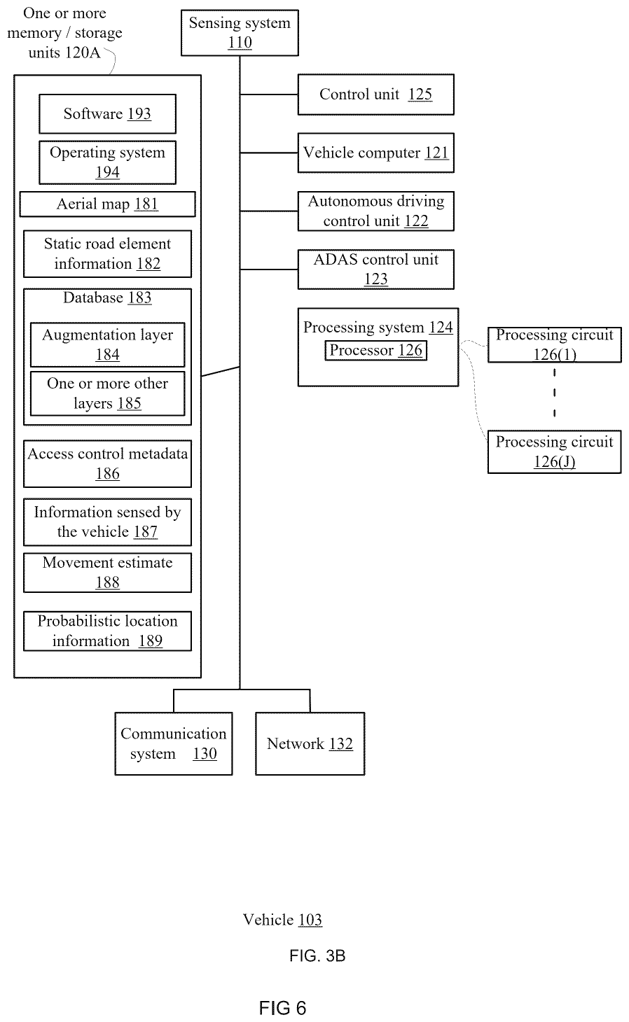

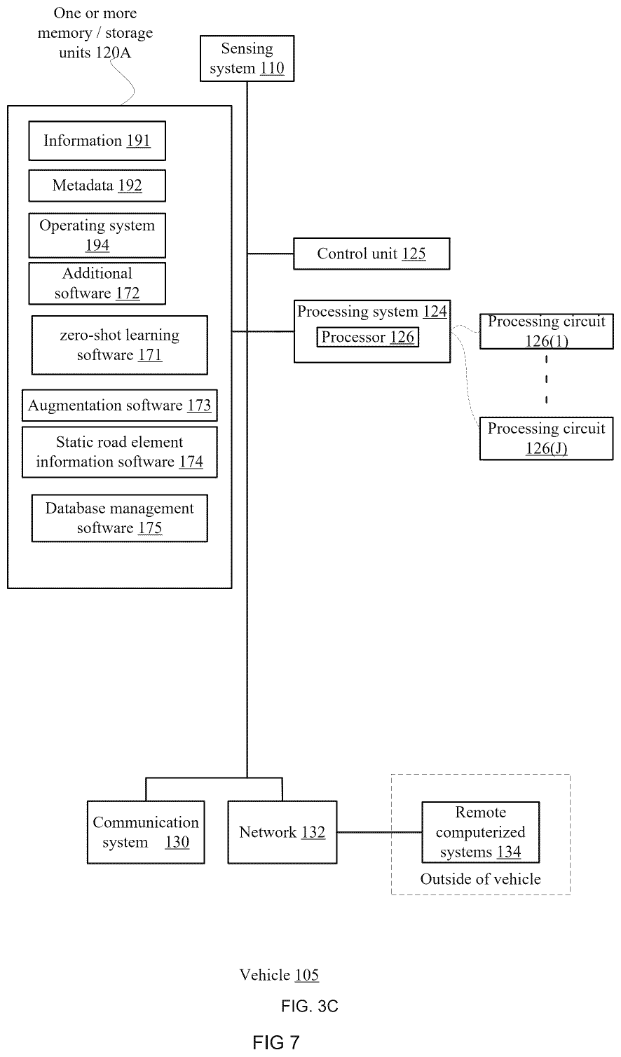

According to an embodiment, step 2106 includes obtaining, in real time, ground detection output that is being generated for the given road setting by a perception unit of the vehicle. Examples of a perception module are illustrated in FIGS. 3A, 3B, and 3C and include at least the processing system 124.

According to an embodiment, the cross-view based localization is generated by a matching air-based signatures with corresponding ground-based signatures.

According to an embodiment, the road setting is a road lane.

According to an embodiment, the real-time fine-tuned localization of the vehicle is provided such that the ground detection output and the data layer information are aligned on the ground image.

According to an embodiment, the data layer information is associated with one or more layers that are selected out of multiple data layers, wherein each data layer is associated with a different type of object.

According to an embodiment, the ground detection output pertains to static road elements within the region of view of the vehicle.

According to an embodiment, steps 2102, 2104 and 2106 are followed by step 2108 of providing real-time fine-tuned localization of the vehicle, by continuous alignment of the ground detection output in accordance with the data layer information, for the given road setting, wherein the real-time fine-tuned localization of the vehicle exhibits an accuracy level that is higher than the cross-view based localization.

According to an embodiment, the continuous alignment involves registering the road settings from the data layer information and road settings associated with the ground detection output generated by the perception unit information, in a shared coordinate system.

According to an embodiment, step 2108 includes fusing the information gathered in steps 2102, 2104 and 2106.

According to an embodiment, step 2108 includes registering road objects, from the road object location information, and road objects, associated with the localization information, in a shared coordinate system. Following the registering, the locations of the objects as captured in the different types of information may be used to determine the location of the vehicle—for example by using triangulation.

Yet for another example, step 2108 may include solving any mismatches associated with locations of an object captured in one or more types of the information. The solving may be based on an accuracy associated with the detection of the object at the different types of information—for example real time data layer information (especially data layer information generated and/or verified by a trusted entity such as the police of a municipal authority) may be more accurate in relation to ground view information. Yet for another example—older information may be deemed less reliable than more updated information.

According to an embodiment, step 2108 includes registering road objects from the road object location information and road objects associated with the vehicle location estimates generated by the perception unit information in a shared coordinate system.

According to an embodiment, method 2101 also includes step 2130 of method 2100.

According to an embodiment, method 2101 (for example if including step 2130) includes populating the database with the data layer by registering localization information of road settings from the air based data of the air based image with localization information of road settings associated with the environmental information of a ground image, in a shared coordinate system.

### Vehicle Localization Using Aerial Information and Ground Vehicle Based Information

Referring now to the drawings, FIGS. 1A-1C are schematic diagrams of a system 100 for determining a vehicle location according to embodiments of the disclosure. As shown in FIG. 1A, the system 100 may include a cross-view localization module 102, a visual odometry module 104, a sensor module 106, and a fusion module 108.

Inputs into the system 100, or one or more system components, may include aerial images 216, aerial image segment signatures 218, vehicle sensed images 220 (at least some of which are acquired at different points in time), vehicle sensed image signatures 222, movement estimates 224, motion information 226, and a probabilistic location information 228, each of which shall be discussed in greater detail herein. For instance, inputs may include an image from the vehicle (for example, a 360-degree surround view image taken by a front camera of the vehicle), a satellite image, a GPS signal, and any additional information such as velocity from controller area network (CAN) signals and/or an inertial measurement unit (IMU).

Inputs may be processed by the cross-view localization module 102. FIG. 1B is a schematic diagram of the cross-view localization module 102 of FIG. 1A. The cross-view localization module 102 is configured to obtain a plurality of sensed images from, for example, a sensing unit of the vehicle and is further configured to receive a plurality of aerial images or image segments from, for example a satellite feed.

As is further illustrated in FIG. 1B, the cross-view localization module 102 is configured to obtain a plurality of aerial images or aerial image segments. According to embodiments of the disclosure, the cross-view localization module 102 may be configured to receive a plurality of aerial images or image segments of a region in which the vehicle is located. To this end, the cross-view localization module 102 is configured to receive a plurality of inputs from one or more outside-the-vehicle sources. Outside-the-vehicle sources may include satellite images or GPS location information.

A coverage area (i.e., a specified image capture area) for a captured aerial image segment may be determined. The required coverage area of a specified image capture area may be determined in advance or in a dynamic manner. For example, if the ground vehicle is located in an urban area, or another area that exhibits a high density of objects, then the aerial image coverage area may be reduced. Alternatively, if the ground vehicle is located in a rural, desolate, isolated or other area only sparsely populated with objects, then the aerial image coverage area may be increased. Modifications to the coverage area may be assisted by coarse location information of the ground vehicle. Such coarse location information may be received from, for example, by as a global positioning satellite (GPS) system, a cellular location system, and the like.

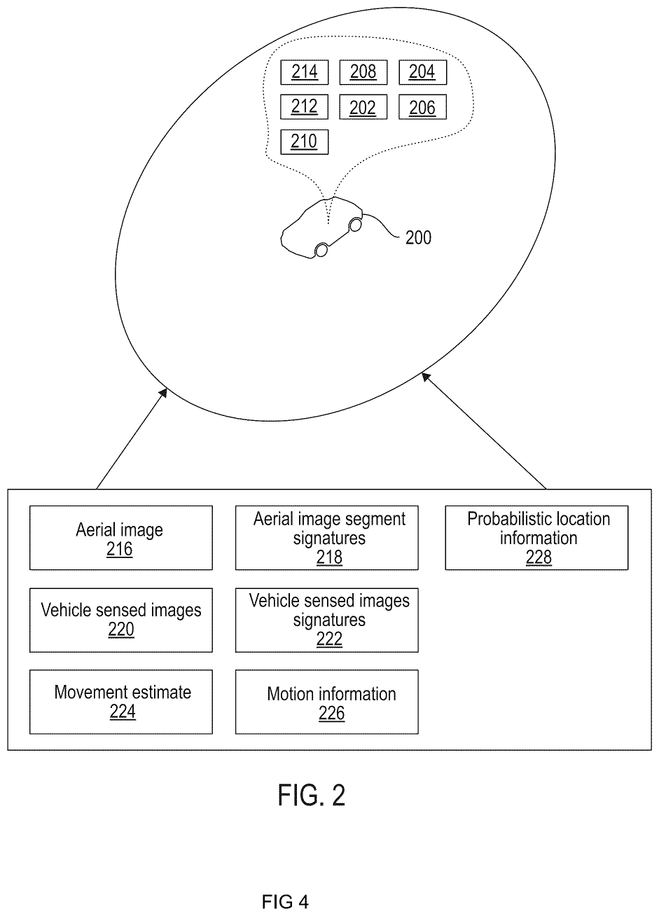

The cross-view localization module 102 is further configured to receive a plurality of sensed images. To this end, the system 100 is configured to receive a plurality of sensed inputs from one or more in-vehicle sources. FIG. 2 illustrates a ground vehicle 200 including a plurality of components. According to embodiments of the disclosure, a ground vehicle 200 including the location system 100 as described herein may include a vehicle sensing unit 202 that further includes one or more sensors such as vehicle sensors 204 and 206. The vehicle sensors 204, 206 may include multiple image sensors and one or more non-image sensors. The vehicle sensors 204, 206 may be image capture devices (such as cameras), audio sensors, infrared sensors, radar, ultrasound sensors, electro-optics sensors, radiography sensors, Lidar (light detection and ranging) sensors, thermal sensor sensors, passive sensors, active sensors, etc. The plurality of sensed images may be received at a plurality of time intervals.

The ground vehicle 200 may also include one or more processing circuits 208, memory unit 210, communication unit 212, and one or more vehicle units 214 such as one or more vehicle computers, units controlled by the one or more vehicle units, motor units, chassis, wheels, and the like. The one or more processing circuits 208 are configured to execute the systems and methods disclosed herein.

According to an embodiment, the ground vehicle sensed images are 360-degree ground vehicle sensed images. In this instance, each ground vehicle sensed image covers a 360-degree sample of the environment of the ground vehicle. According to an embodiment, the ground vehicle sensed images cover less than 360 degrees. Including a broader coverage area in the ground vehicle sensed image may increase the accuracy of the location detection. Including a narrower coverage area in the ground vehicle sensed image may require less bandwidth and may therefore be less expensive to execute.

According to an embodiment, a sensed image is generated by acquiring a plurality of ground vehicle sensed images. The ground vehicle sensed images may be of different angular segments of a vehicle's field of view. The different angular segments may be acquired by different image sensors having different fields of views (differ by at least by their polar angle coverage), and/or may be acquired by scanning the environment of the ground vehicle—for example using movable image sensors or image sensors preceded by optics of an adjustable field of view. The plurality of ground vehicle sensed images may be captured in close-timing proximity (e.g., within a fraction of a second from each other). The plurality of ground vehicle sensed images, or at least a portion of the visual information contained therein, may then be stitched or otherwise combined to provide a 360-degree ground vehicle sensed images.

The sensed images and aerial images may be translated into image signatures, by for example, a processor (e.g., the cross-view localization module 102). An image signature of a detected region (e.g., a ground vehicle-sensed image or an aerial image) may be defined as information regarding one or more other regions of the image.

To generate the image signatures from sensed images and/or aerial images or image segments, the cross-view localization module 102 may include a ground encoder 120 and an aerial encoder 122. The ground encoder 120 is configured to extract a sensed image signature (e.g., a ground-vehicle image signature) from an image captured by a vehicle sensor. The sensed image signature contains ground image information of a captured image segment that is needed to perform a comparison between the image segment and at least one additional input (e.g., a satellite image). A plurality of sensed image signatures may be obtained at a plurality of time intervals.

The aerial encoder 122 extracts a plurality of aerial image signatures from, for example, received satellite images. Aerial image segment signatures are composed of information relating to aerial image segments of a region in which a vehicle may be located (i.e., the specified image capture area). Each aerial image signature includes information regarding the selected specified image capture area. Signatures of an aerial segment or a subsegment of an aerial segment (e.g., a segment patch) may be generated by applying a self-attention mechanism to the segment or the segment patch. A self-attention mechanism may be a mechanism that computes attention scores between patches, based, for example, on the content and position of an object in the image. The self-attention mechanism may be included in a transformer neural network.

The cross-view localization module 102 is also configured to match an aerial image segment signature of the plurality of aerial image segment signatures to a sensed image signature of the plurality of sensed image signatures. As shown in FIG. 1C, a process for matching a sensed (ground) image signature to an aerial image signature is shown. Prior to input into the cross-view localization module 102, the ground view image and the aerial image may be divided into one or more sections or a grid. Once an image is input into the cross-view localization module 102, in, for instance, a grid formed from individual image segments, a linear projection of the one or more grid segments may be calculated. A ground view image class embedding and position embedding, as well as a plurality of ground position and patch embeddings may be created from the linear projection. Similarly, an aerial image class and position embedding, and a plurality of aerial position and patch embeddings may be created from the linear projection.

The respective class/position embeddings and position/patch embeddings may be fed into the ground encoder 120 and the aerial encoder 122, respectively. In such instances, the ground encoder 120 and the aerial encoder 122 may be Vision Transformer (ViT) encoders or may leverage another like deep learning architecture. The output of the ground encoder 120 may be a ground image class token and a plurality of ground image patch tokens. The output of the aerial encoder 122 may be an aerial image class token and a plurality of aerial image patch tokens. A multi-layer perceptron function may be performed on the ground encoder class token and the plurality of aerial patch tokens.

The system is trained with attention mechanisms to locate the best representations and matching between aerial image signatures and sensed image signatures. For instance, the cross-view localization module 102 may apply a contrastive loss function to the input tokens. In such instances, the training process may include feeding the machine learning process with ground vehicle sensed images at different points in time and corresponding aerial images. The training process may cause the machine learning process to provide a mapping between the vehicle sensed image signatures and the aerial image segment signatures. The training process may also induce training the machine learning process to (i) provide a similar signature to a ground vehicle sensed image of a region and an aerial image segment signature of that region, and (ii) provide dissimilar signatures to a ground vehicle sensed image and an aerial image segment of different regions. In some instances, the training process relies on a neural network such as an attention mechanism. Other functions configured to determine how well a model can differentiate between similar and dissimilar data points may be utilized.

During an inference phase,, a cosine similarity function may be applied. Other functions configured to a measure of similarity between two non-one vectors defined in an inner product space may be utilized.

Probabilistic location information is then generated from the processing steps performed by the cross-view localization module 102. For instance, the cross-view localization module 102 is further configured to generate probabilistic location information (e.g., a probability map) regarding the location of the vehicle during the plurality of time intervals. The probabilistic location information is based on the matching of the aerial image segment signature and the sensed image signature. For example, the sensed image signature and the aerial image signature are compared against each other to create probabilistic location information. As mentioned above, the aerial image signatures input into the cross-view localization module 102 may be constructed during training such that they contain relevant data from other patches of the satellite image. This may be executed by utilizing a self-attention mechanism, i.e., a mechanism that computes attention scored between patches, based, for example, on content and position in the image. Determining a probabilistic location of the ground vehicle includes determining the location information at a sub-patch resolution. A sub-patch refinement module may be applied to accurately estimate the location of the camera in the satellite image. For instance, with respect to a received satellite patch, one or more satellite patch neighbors may be fused to indicate where inside the patch the location probability is the highest. Alternatively, up-sampling (i.e., using an up-sampled version of the aerial image) may be utilized on the satellite image.

According to an embodiment, the probabilistic location information is a heatmap. A color of a heatmap pixel is indicative of a probability that the vehicle is located at the heatmap pixel. For instance, a high concentration of red pixels may indicate a high location probability.

The system is further configured to obtain a movement estimate of the vehicle during the plurality of time intervals. In some embodiments, the movement estimate may be obtained from the visual odometry module 104. For example, the visual odometry module 104 may be configured to analyze a plurality of sensed images received from a vehicle sensor (e.g., one or more of sensors 204, 206). The movement estimate is generated based on a vehicle location comparison across the plurality of sensed images. For instance, the visual odometry module 104 may detect an object in a first received image. The visual odometry module 104 may then search for the object in subsequent images and calculate or estimate vehicle movement information from the differences in position of the detected object. The object may be stationary to allow for a comparison of the vehicle in motion to the object at discrete time intervals. In some embodiments, velocity information may be extracted from controller area network (CAN) signals. The visual odometry module 104 may then use the received inputs to update vehicle location as the vehicle traverses a path.

According to an embodiment, motion information may be gained from non-image sensors of the ground vehicle. The system may further comprise a sensor module 106 configured to receive inputs from a plurality of sensors (examples of which are described above in FIG. 2). The motion information may therefore be obtained by at least one sensor, such as a vehicle direction or propagation sensor (e.g., a sensor configured to determine the direction of propagation of the vehicle), an accelerometer, and the like. Sensor module information may be combined with the cross-view localization module output and/or the visual odometry output.

The system 100 is further configured to determine the location of the vehicle by fusing or combining the movement estimate of the vehicle and the probabilistic location information. For instance, the fusion module 108 may combine or fuse input location information. The fusion module 108 may be a particle filter, such as a Bayes filter or a Kalman filter. Determining the location of the ground vehicle may be based on, or solely on, a combination or fusing of the movement estimate of the ground vehicle, the probabilistic location information and coarse ground vehicle location information. Alternatively, determining the location of the ground vehicle may be based on, or solely on, a combination or fusing of the movement estimate of the ground vehicle, the probabilistic location information and motion information gained from non-image sensors of the ground vehicle. Determining the location of the ground vehicle may be based on, or solely on, a combination or fusing of the movement estimate of the ground vehicle, the probabilistic location information, motion information gained from non-image sensors of the ground vehicle and coarse ground vehicle location information.

According to an embodiment, the fusing is executed by a machine learning process of the fusion module, the machine learning process has undergone a training process in which it learns to fuse outputs from the cross-view localization module and the visual odometry module.

Determining the location of the ground vehicle may further include triggering a determination of an autonomous driving operation. Thus, the determining the location of the ground vehicle may further include determining the autonomous driving operation, and/or executing the autonomous driving operation. According to embodiments of the disclosure, the autonomous driving operation includes at least one of autonomously controlling a speed and/or direction of propagation and/or acceleration of a vehicle. The autonomous driving operation may also be an emergency breaking operation, a lane maintaining driving operation, a lane changing driving operation, and the like.

A resultant location indication may be accurate to a sub-10 cm offset. The system is able to perform vehicle localization in any location without the need for the particular road to have been driven by the vehicle previously. The system 100 may be configured to execute offline, by leveraging highly compressed aerial image signatures stored in the system.

### Data Layers

The following text provides examples of generating localization information and of generating data layers and using data layers for localization, such as improving localization of an ego vehicle in driving, for path planning, for decision making and control operations, and in general for other autonomous driving applications.

FIG. 3A illustrates an example of a vehicle 101, a network 123 and remote computerized systems 134.

The vehicle 101 includes (a) sensing system 110, a communication system 130, one or more memory and/or storage units 120A, and additional units that include control unit 125 (in FIGS. 8B and 8C there are also a vehicle computer 121, and advanced driver assistance system (ADAS) control unit 123, autonomous driving control unit 122), processing system 124 including processor 126. Network 123 is in communication with the vehicle and with the remote computerized systems 134 such as servers, cloud computers, and the like.

Communication system 130, one or more memory and/or storage units 120A, and processing system 134 may form a computerized system. The computerized system may include one or more other systems and/or units such as sensing system 110.

The communication system 130 is configured to enable communication between the one or more memory and/or storage units 120A and/or the sensing system 110 and/or any one of the additional units and/or the network 132 (that is in communication with the remote computerized systems).

The control unit 125 is configured to control various operations related to the vehicle—such as but not limited to various steps of method 600.

The one or more memory and/or storage units 120A are illustrated as storing an operating system 194, software 193 (especially software required to execute method 200), information 191 and metadata 192 (especially information and metadata required to execute method 200). The information may include environmental information. The metadata may include any metric or an outcome of processed information-especially related to the execution of method 200.

FIG. 3B and FIG. 3C differ from FIG. 3A by illustrating vehicle 103 and 105 respectively that have their one or more memory and/or storage units 120A store more examples of content stored in the.

The sensing system 110 may include optics, a sensing element group, a readout circuit, and an image signal processor. Optics are followed by a sensing element group such as line of sensing elements or an array of sensing elements that form the sensing element group. The sensing element group is followed by a readout circuit that reads detection signals generated by the sensing element group. An image signal processor is configured to perform an initial processing of the detection signals—for example by improving the quality of the detection information, performing noise reduction, and the like. The sensing system 110 is configured to output one or more sensed information units (SIUs).

The communication system 130 is configured to enable communication between the one or more memory and/or storage units 120A and/or the sensing system 110 and/or any one of the additional units and/or the network 132 (that is in communication with the remote computerized systems).

The controller 125 is configured to control the operation of the sensing system 110, and/or the one or more memory and/or storage units 120A and/or the one or more additional units (except the controller).

The ADAS control unit 123 is configured to control ADAS operations.

The autonomous driving control unit 122 is configured to control autonomous driving of the autonomous vehicle.

The vehicle computer 121 is configured to control the operation of the vehicle—especially controlling the engine, the transmission, and any other vehicle system or component.

The processing system 124 may include processor 146 and one or more other processors and is configured to execute any method illustrated in the specification.

The one or more memory and/or storage units 120A are configured to store firmware and/or software, one or more operating systems, data and metadata required to the execution of any of the methods mentioned in this application.

FIGS. 3B and/or FIG. 3C illustrates the one or more memory and/or storage units 120A as storing at least some of:
Aerial map 181.
Static road element information 182.
Database 183 that may store the aerial map (in one or more layers 185) and augmented information (including the static road element information) within augmentation layer 184 (or not within a dedicated augmentation layer).
Access control metadata 186 for controlling access to the database 183.
Information sensed by the vehicle 187.
Movement estimate 188 that may be generated by a visual odometry module.
Probabilistic location information 189.
Zero-shot learning software 171.
Static road element information software 174 for generating the Static road element information 182.
Database management software 175 configured to augment the aerial map and/or to control a transmission of the content of the database and/or for access control.
Operating system 194.
Additional software 172 that may be used to perform any other functionality of the vehicle and/or of any of the other units illustrated in FIGS. 3A-3C.

The vehicle computer 121 may be in communication with an engine control module, a transmission control module, a powertrain control module, and the like

The memory and/or storage units 120A was shown as storing software. Any reference to software should be applied mutatis mutandis to code and/or firmware and/or instructions and/or commands, and the like.

Processor 126 includes a plurality of processing units 126(1)-126(J), J is an integer that exceeds one. Any reference to one unit or item should be applied mutatis mutandis to multiple units or items. For example—any reference to processor should be applied mutatis mutandis to multiple processors, any reference to communication system 130 should be applied mutatis mutandis to multiple communication systems.

According to an embodiment, the one or more memory and/or storage units 120A includes one or more memory unit, each memory unit may include one or more memory banks.

According to an embodiment, the one or more memory and/or storage units 120A includes a volatile memory and/or a non-volatile memory. The one or more memory and/or storage units 120A may be a random-access memory (RAM) and/or a read only memory (ROM).

According to an embodiment, the non-volatile memory unit is a mass storage device, which can provide non-volatile storage of computer code, computer readable instructions, data structures, program modules, and other data for the processor or any other unit of vehicle. For example, and not meant to be limiting, a mass storage device can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any content may be stored in any part or any type of the memory and/or storage units.

According to an embodiment, the at least one memory unit stores at least one database—such as any database known in the art—such as DB2®, Microsoft® Access, Microsoft® SQL Server, Oracle®, mySQL, PostgreSQL, and the like.

Various units and/or components are in communication with each other using any communication elements and/or protocols. An example of a communication system is denoted 130. Other communication elements may be provided.

FIGS. 3A-3C illustrate communication system 130 as being in communication with various processors and/or units and network 132.

It should be noted that at least a part of the content illustrated as being stored in one or more memory/storage units 120A may be stored outside the vehicle—fir example database 193 or any part thereof may be stored outside the vehicle. It should also be noted that the processor may evaluate signatures generated by a plurality of detectors.

According to an embodiment, the processor is configured to perform at least one of the following:
Obtain static road element information regarding a location of static road elements within a region. The static road information is obtained by applying zero-shot learning based on information sensed by a vehicle.
Augment the aerial map using the static road element information, wherein the augmenting of the aerial map comprises populating a database.
Respond to the updating—for example by granting access to the database to defined entities and/or by delivering the populated database as a downable software to a recipient.

According to an embodiment, the static road information is based on a movement estimate of a road vehicle and on probabilistic location information indicative a location of the road vehicle within the aerial map.

According to an embodiment, the processor is configured to obtain the static road element information by at least one of the following:
Receive the information sensed by a vehicle.
Process the information referred to as the information sensed by the vehicle.
Generate the static road information by applying zero-shot learning.
Receive the static road information. For example-retrieve the static road information, store the static road information, access a local or remote memory unit to obtain the static road information.
Adding static road element information about a static road element that is absent from the aerial map.
Replace static road element information about a static road element that is absent from the aerial map.
Augment the aerial map using static road element information being in relevancy to a driving path of the vehicle. For example—more weight is assigned to static road elements that are proximate to the driving path of the vehicle—for example, within 1-20 meters from the driving path. According to an embodiment, there may be provided different distance ranges related to distances of static road elements from the driving path—and the different distance ranges are associated with different weights.
Selectively augment the aerial map based on one or more rules—such as: (i) allocate weight to static road element information based on a time that the static road element information was generated (especially the time difference between the generation of the aerial map and the last generated static road element information), (ii) allocate weight to static road element information based on a number of vehicles that reported the presence of the static object, (iii) allocate weight to static road element information based on a confidence level associated with at least one of the aerial map and the static road element information. The confidence level may be generated in various manners—for example by a computerized entity that generated the static road element information. The confidence level may be dependent on one or more parameters such as signal to noise of the information sensed by the vehicle, success rates of the zero-shot learning process, sensing information acquisition parameters (for example—quality or intensity of illumination weather conditions). The confidence level may be based verification or triangulation of the location of the static road element—for example—a higher confidence level may be assigned when the static road element information is generated by sensed information obtained by the vehicle in which the static road element is sensed from different angles (while the vehicle moved in relation to the static road element)—or when the vehicle verifies the location of the static road element based on sensed information obtained by the vehicle in which the static road element is sensed from different angles. (iv) Update the aerial map when the weight assigned to the static road element information exceed by at least a predefined amount the weight assigned to the aerial map. (v) Apply a hysteresis that imposes a minimum time between consecutive updates of the aerial map to reduce the rate of successive aerial map updates. (iv) updating the aerial map based on resource constraints—for example memory constraints, communication constraints and/or processing resource constraints.
Populate an augmentation layer of the aerial map with the static road element information. The aerial map (without the augmentation) may be stored in one or more other layers of the database.

FIG. 4A illustrates an example of method 1700 that is computer implemented and is for data layer augmentation.

According to an embodiment, method 1700 included step 1710 of obtaining, by a processor associated with a vehicle, a data layer associated with road elements of a specified type.

According to an embodiment, method 1700 also includes step 1720 of obtaining, by a processor associated with a vehicle, localization information regarding a location of the vehicle. The road element information is obtained based on aerial image information within a region of a vehicle and on environmental information sensed by the vehicle. Examples related to the localization information are illustrated in FIG. 1C.

According to an embodiment steps 1710 and 1720 are followed by step 1730 of augmenting the data layer using the localization information, wherein the augmenting of the data layer includes populating a database with data representing updated road elements location for a group of road elements of the specified type within the region of the vehicle.

According to an embodiment, the augmenting comprises adding one or more road elements that were absent from the data layer, deleting one or more road elements that were previously include in the data layer and/or changing a location of one or more road elements that associated with incorrect locations within the data layer.

According to an embodiment, the group of road elements are relevant to a driving path of the vehicle. According to an embodiment, method 1700 includes ignoring road elements that are outside the path (at least within a defined distance from the path).

According to an embodiment the aerial map is much richer than the data layer-as it is not limited to road elements of a specified type.

According to an embodiment, the road information is obtained based on a mapping between aerial image information signatures and environmental signatures. Examples related to the mapping are illustrated in FIG. 1C and other figures.

According to an embodiment, the augmenting involves updating data layer signatures. A data layer signature is a signatures that represents a road element of the specified type.

According to an embodiment, the localization information is based on a movement estimate of a road vehicle and on probabilistic location information indicative a location of the road vehicle within the aerial map.

According to an embodiment, the road element information is based on a sub-lane resolution determination of the location of the vehicle.

According to an embodiment, method 1700 includes step 1740 of delivering the populated database as a downable software to a recipient. According to an embodiment, the recipient is the entity that defined the specified type of road elements to be represented in the—or an entity that did not define the specified type.

According to an embodiment, the database is stored within a memory unit of the vehicle.

According to an embodiment, the database is access controlled and method 1700 includes step 1750 of granting access to the database to defined entities. The defined entities may include the entity that defined the specified type of road elements to be represented in the—and/or may include or an entity that did not define the specified type.

FIG. 10B illustrates an example of content (software and/or information) stored in one or more storage/memory units for use in implementing method 1700.

The content may include at least one of:
Aerial map 1801.
Localization information 1802 indicative of at least one of a location of a vehicle and/or locations of road elements of (at least) a specific type.
Database 1803 that includes data layer 1804 that includes information regarding includes information regarding road elements of one or more specified types. The information includes at least the locations of the road elements.
Access control metadata 1806 for controlling access to the data layer.
Movement estimate 1806 for storing information about a movement of the vehicle.
Probabilistic location information 1809 indicative a location of the road vehicle within the aerial map. Examples of the movement estimate 1808 and of the probabilistic location information 1809 are illustrated in FIGS. 1A-1C,—(for example—the visual odometry module 104, the probability map, probabilistic location information 228, motion information 226, localization probability heatmaps).
Localization software 1873 configured to generate localization information indicative of the location of (at least) the vehicle and road elements.
Data layer software 1874 configured to generate and update the data layer.
Database management software 1875 configured to control the generation and maintenance of database 1803.

Because some aspects of the illustrated embodiments of the present disclosure

may, for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any combination of any steps of any method illustrated in the specification and/or drawings may be provided. Any combination of any subject matter of any of claims may be provided. Any combinations of systems, units, components, processors, sensors, illustrated in the specification and/or drawings may be provided. Any combination of any module or unit listed in any of the figures, any part of the specification and/or any claims may be provided.

Any reference in the specification to a method should be applied mutatis mutandis to a device or system capable of executing the method and/or to a non-transitory computer readable medium that stores instructions for executing the method. Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

In the foregoing specification, the invention has been described with reference to specific examples of embodiments of the invention. It will, however, be evident that various modifications and changes may be made therein without departing from the broader spirit and scope of the invention as set forth in the appended claims. The specifications and drawings are, accordingly, to be regarded in an illustrative rather than in a restrictive sense.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Those skilled in the art will recognize that boundaries between the above-described operations are merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Thus, the scope of the embodiments of the disclosure is defined by the appended claims and equivalents thereof. While certain features of the disclosure have been illustrated and described herein, many modifications, substitutions, changes, and equivalents will now occur to those of ordinary skill in the art. It is therefore to be understood that the appended claims are intended to cover all such modifications and changes as fall within the true spirit of the invention.

We claim:

1. A method that is computer implemented and is for real-time cross-view localization of a ground vehicle, the method comprising:
obtaining, by a processor associated with a vehicle, a cross-view based localization of the vehicle, wherein the cross-view based localization is determined by using air based data of an air based image within a region of the vehicle in accordance with environmental information of a ground image that is sensed by a sensor of the vehicle at the region of the vehicle;
obtaining, by the processor and by accessing a database that is populated, based on the cross-view based localization, to contain a data layer, data layer information regarding locations of a given road setting within the region of the vehicle;
obtaining, in real time, ground detection output that is being generated for the given road setting by a perception unit of the vehicle; and
providing a real-time fine-tuned localization of the vehicle, by continuous alignment of the ground detection output in accordance with the data layer information, for the given road setting, wherein the real-time fine-tuned localization of the vehicle exhibits an accuracy level that is higher than the cross-view based localization.

2. The method according to claim 1, wherein the cross-view based localization is generated by a matching of air-based signatures with corresponding ground-based signatures.

3. The method according to claim 1, wherein the road setting is a road lane.

4. The method according to claim 1, wherein the real-time fine-tuned localization of the vehicle is provided such that the ground detection output and the data layer information are aligned on the ground image.

5. The method according to claim 1, wherein the data layer information is associated with one or more layers that are selected out of multiple data layers, wherein each data layer is associated with a different type of object.

6. The method according to claim 1, wherein the ground detection output pertains to static road elements within the region of view of the vehicle.

7. The method according to claim 1, further comprising populating the database with the data layer by registering localization information of road settings from the air based data of the air based image with localization information of road settings associated with the environmental information of a ground image, in a shared coordinate system.

8. The method according to claim 1, wherein the continuous alignment involves registering the road settings from the data layer information and road settings associated with the ground detection output generated by the perception unit information, in a shared coordinate system.

9. A computer-readable medium storing instructions for real-time cross-view localization of a ground vehicle that, when executed by at least one processing device associated with a vehicle, cause the at least one processing device to:
obtain a cross-view based localization of the vehicle, wherein the cross-view based localization is determined by using air based data of an air based image within a region of the vehicle in accordance with environmental information of a ground image that is sensed by a sensor of the vehicle at the region of the vehicle;
obtain, by accessing a database that is populated, based on the cross-view based localization, to contain a data layer, data layer information regarding locations of a given road setting within the region of the vehicle;
obtain ground detection output that is being generated for the given road setting by a perception unit of the vehicle; and
provide real-time fine-tuned localization of the vehicle, by continuous alignment of the ground detection output in accordance with the data layer information, for the given road setting, wherein the real-time fine-tuned localization of the vehicle exhibits an accuracy level that is higher than the cross-view based localization.

10. The computer-readable medium according to claim 9, wherein the cross-view based localization is generated by a matching of air-based signatures with corresponding ground-based signatures.

11. The computer-readable medium according to claim 9, wherein the road setting is a road lane.

12. The computer-readable medium according to claim 9, wherein the real-time fine-tuned localization of the vehicle is provided such that the ground detection output and the data layer information are aligned on the ground image.

13. The computer-readable medium according to claim 9, wherein the data layer information is associated with one or more layers that are selected out of multiple data layers, wherein each data layer is associated with a different type of object.

14. The computer-readable medium according to claim 9, wherein the ground detection output pertains to static road elements within the region of view of the vehicle.

15. The computer-readable medium according to claim 9, wherein the processing device further storing instructions causing the processing device to populate the database with the data layer by registering localization information of road settings from the air based data of the air based image with localization information of road settings associated with the environmental information of a ground image, in a shared coordinate system.

16. The computer-readable medium according to claim 9, wherein the processing device provides the real-time fine-tune localization by continuous alignment of the ground detection output in accordance with the data layer information that involves registering the road settings from the data layer information and road settings associated with the ground detection output generated by the perception unit information, in a shared coordinate system.
